(19) United States
(12) Patent Application Publication
(10) Pub. No.: US 2007/0221545 A1
(43) Pub. Date: Sep. 27, 2007

(54) Initial/minute sieving and sorting facility of garbage

(76) Inventor: Chin-Hui Liu, Taiping City (TW)

Correspondence Address: TROXELL LAW OFFICE PLLC, SUITE 1404, 5205 LEESBURG PIKE, FALLS CHURCH, VA, 22041, US

(21) Appl. No.: 11/385,842

(22) Filed: Mar. 22, 2006

(51) Int. Cl. B07B 1/22; B07B 13/00; B07C 5/12

(52) U.S. Cl. 209/289; 209/930; 209/683

(57) ABSTRACT

An initial/minute sieving and sorting facility of garbage which is composed of garbage-collecting bin, 2 recycle bins driven by motor and chain for rotation, conveying belt locating at bottom of recycle bin, conveying device connecting with recycle bin and lower edge of conveying belt. Wherein garbage is put into higher end of slanting set recycle bin from feed hopper of garbage-collecting bin, meshes in large aperture are made over recycle bin, its lower end is extended to connect with conveying device in manpower-selecting zone; conveying belt with casing is fixed at bottom of recycle bin, another conveying device is connected with its lower edge, then another set of conveying device extends its one end into higher end of recycle bin, meshes in small aperture are set on this recycle bin, conveying belt and conveying device collecting minute-sieved garbage are also fixed below recycle bin, furthermore, one set of conveying device is also connected with lower end of recycle bin; basing on rotation of recycle bin, garbage smaller than big aperture can drop into conveying belt from mesh, large garbage that cannot drop off from mesh may come out from lower end so as to finish initial sieving; then conveying device receives the initially sieved garbage dropping into conveying belt and conveys into recycle bin with small aperture mesh, garbage smaller than small aperture can drop into conveying belt from mesh due to rotation of recycle bin, garbage that cannot pass mesh may come out from lower end, therefore, garbage can be further sieved and effectively sorted accordingly.

### BACKGROUND OF THE INVENTION

1) Field of the Invention

This invention relates to an initial/minute sieving and sorting facility of garbage, wherein one long recycle bin with meshes in different apertures are fixed at different positions. Garbage is sieved with these meshes due to slanting set recycle bin and its rotation, then the sieved garbage is conveyed to follow-on working zone by conveying belt and device with casing, therefore, garbage can be sieved initially and get sorted accordingly, especially such sorting is precise, effective and automatic.

2) Description of the Prior Art

Along with the progress of era and getting rich of people, more and more civilized outcome have been derived from it, so, garbage produced everyday are surprising, the domestic environmental protection agency thought that the improper disposal of garbage may result in serious damage on environment, so, this agency decided to sort and recycle garbage so as to reduce quantity of garbage produced. Most citizens have agreed with sorting and recycle of garbage (home, residential district and even school, governmental agency), but some people still don't follow such appeal, who have been the trouble-makers to sorting measure of environmental protection, this is one of the reasons why sorting and recycle can not be carried through; in addition, the usual methods to recycle and sort garbage are to apply several bins or boxes, vessels to sort paper, glass, metal and plastic wastes; however, these must-needed bins (or boxes) may occupy large area; only recyclable and non-recyclable garbage bin can be placed due to area problem in some public field, furthermore, sorting done by manpower is not good as expected, which may waste lots of manpower and time; therefore, the facility of this invention is finally invented owing to many years' hardworking and experiences in order to improve existing imperfect garbage-sorting method.

### SUMMARY OF THE INVENTION

Key purpose of this invention is to provide an initial/minute sieving and sorting facility of garbage, wherein one long recycle bin with meshes in different apertures are fixed at different positions. Garbage is sieved with these meshes due to slanting set recycle bin and its rotation, then the sieved garbage is conveyed to follow-on working zone by conveying belt and device with casing, therefore, garbage can be sieved initially and get sorted accordingly, especially such sorting is precise, effective and automatic.

Second purpose of this invention is to provide an initial/minute sieving and sorting facility of garbage, wherein this invention is to apply motor to drive chain so that recycle bin can rotate slowly and continuously, the collected garbage may be completely dispersed and get sieved thoroughly by meshes.

Third purpose of this invention is to provide an initial/minute sieving and sorting facility of garbage, wherein the slanting set recycle bin of this invention can let garbage contained in it slide downward easily.

Fourth purpose of this invention is to provide an initial/minute sieving and sorting facility of garbage, wherein all components of this facility can be fitted each other, so it can operate automatically.

### BRIEF DESCRIPTION OF THE DRAWINGS

FIG. 1 is the exploded combination view of this invention.

FIG. 2 is the detailed flow view of this invention.

FIG. 3 is the detailed positioning view for recycle bin and support disc of this invention.

FIG. 4 is the section view of recycle bin of this invention in application.

### DETAILED DESCRIPTION OF THE PREFERRED EMBODIMENTS

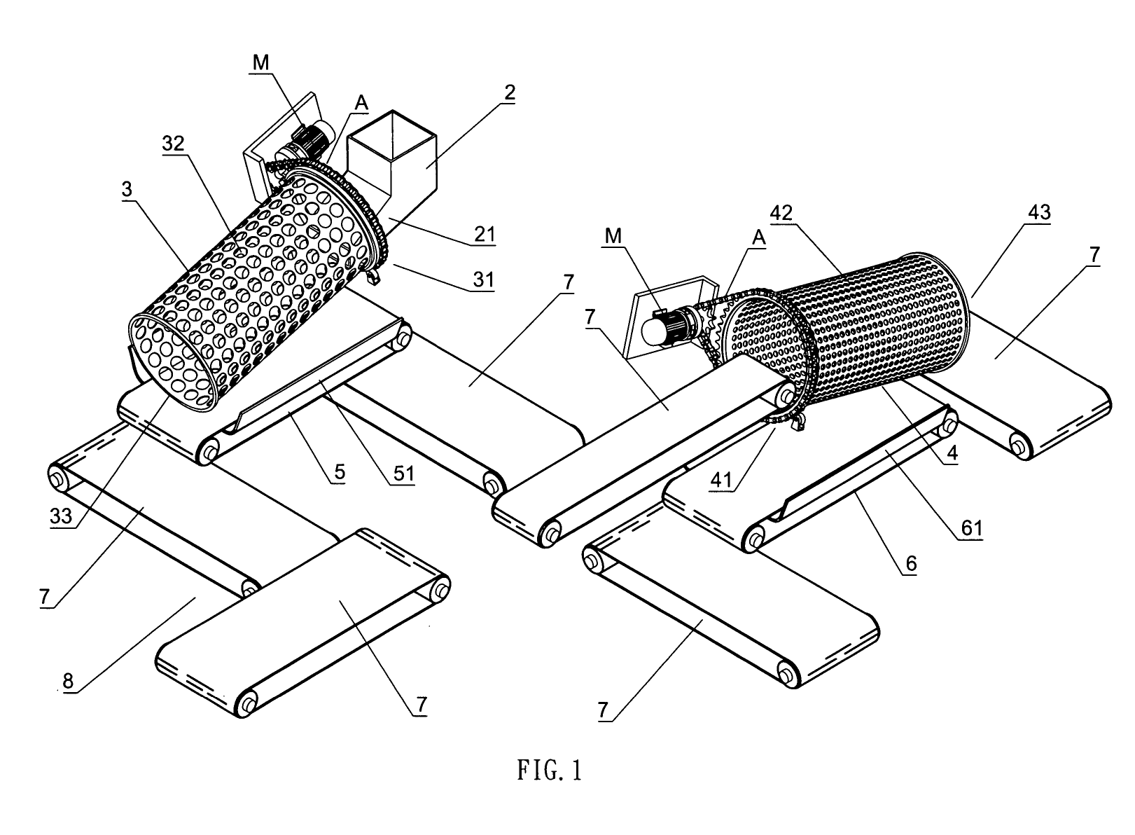

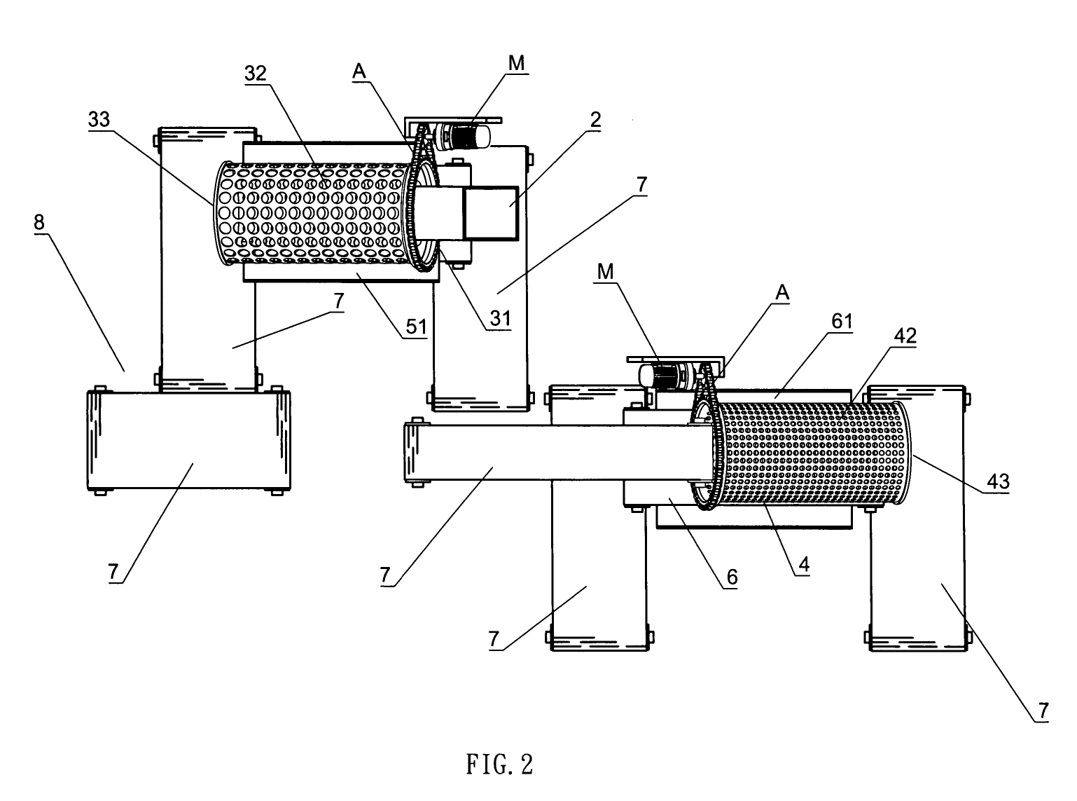

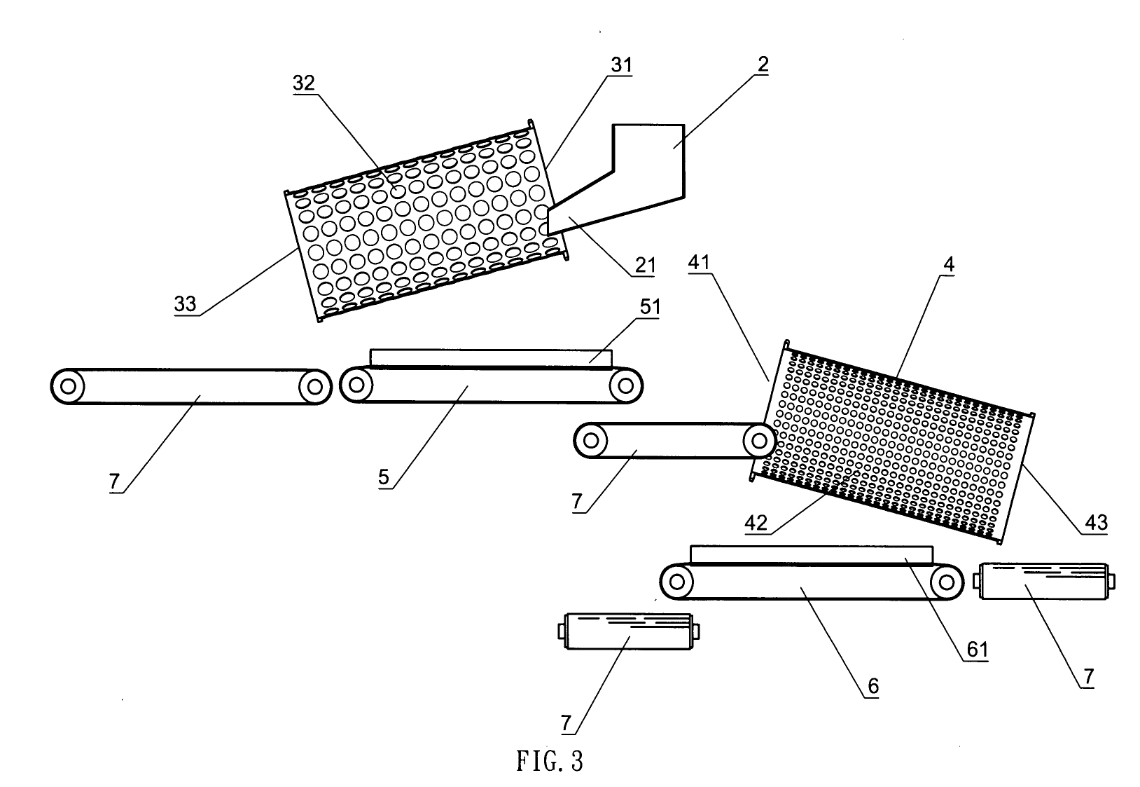

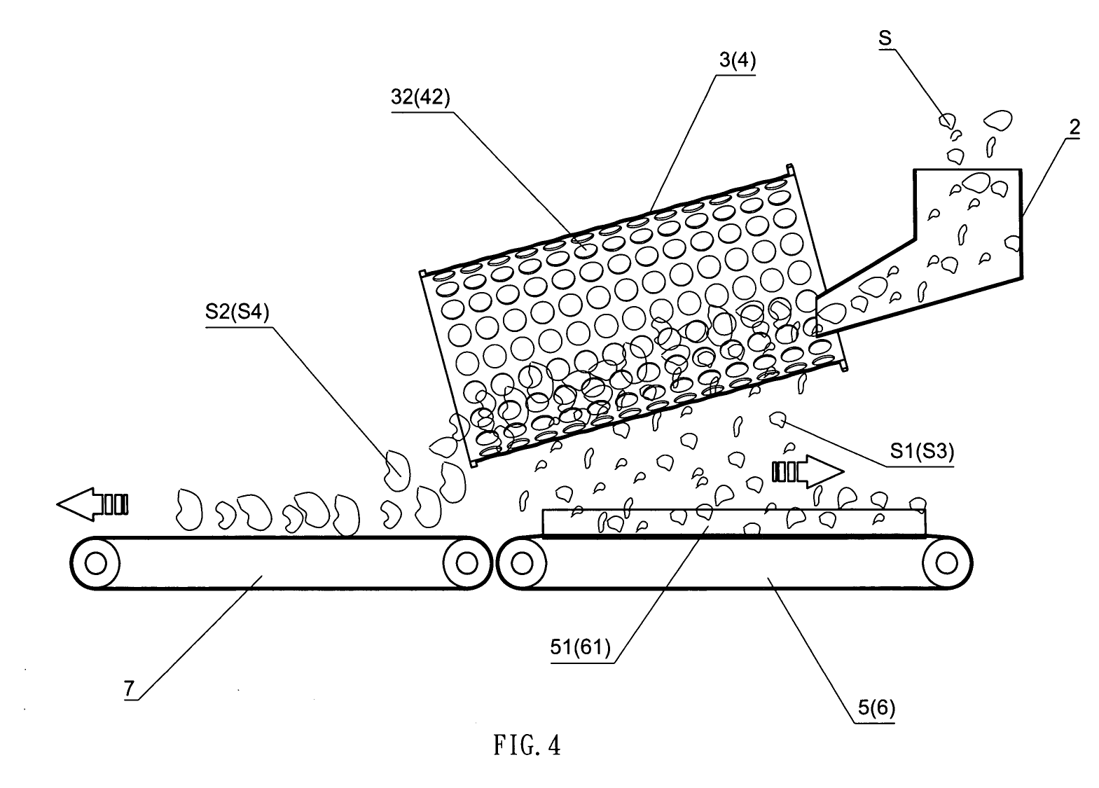

We will hereby describe structure and applied examples of this invention with drawings in the following, please refer to FIG. 1, FIG. 2, FIG. 3 and FIG. 4, this invention is composed of garbage-collecting bin, 2 recycle bins 3 & 4 driven by motor M and chain A for rotation, conveying belt 5 & 6 locating at bottom of recycle bin 3 & 4, conveying device 7 connecting with recycle bin (3,4) and lower edge of conveying belt 5(6). Wherein garbage S is put into higher end 31 of slanting set recycle bin 3 from feed hopper 21 of garbage-collecting bin 3, meshes 32 in large aperture are made over recycle bin 3, its lower end 33 is extended to connect with conveying device 7 in manpower-selecting zone 8 where the large garbage (such as brick, metal or branch) can be sorted as combustible and non-combustible garbage; lower edge of conveying belt 5 with casing 51 fixed at bottom of recycle bin 3 is connected with another conveying device 7, which extends into the higher end 41 of another recycle bin 4, meshes 42 in small aperture are distributed over recycle bin 4, conveying belt 6 with casing 61 for connecting thin sieved garbage is also fixed below recycle bin 4, conveying device 7 finishing the final collection is set below conveying belt 6, furthermore, lower end 43 of recycle bin 4 is connected with another conveying device 7; motor M and chain A drive recycle 3 & 4 to rotate so that garbage S1 less than large aperture may drop to conveying belt 5 from mesh 32 (refer to FIG. 4), the large garbage S2 that can not pass through mesh 32 may drop off from lower end 33, the initial sieving is finished at this time; the initially sieved garbage S1 dropping on conveying belt 5 is sent into recycle bin 4 with small aperture mesh 42 by conveying device 7, garbage S3 less than the small aperture may drop to conveying belt 6 (refer to FIG. 4) from mesh 42 due to rotation of recycle bin 4, it may be conveyed to collection location by conveying device 7; Garbage S4 that can not pass through mesh 42 may drop off from lower end 42 and send to another collection location by conveying device 7 (please refer to FIG. 1 and FIG. 2 for positions of device). Therefore, garbage can be sieved and sorted accordingly.

What is claimed is:

1. An initial/minute sieving and sorting facility of facility which is composed of garbage-collecting bin, 2 recycle bins driven by motor and chain for rotation, conveying belt locating at bottom of recycle bin, conveying device connecting with recycle bin and lower edge of conveying belt. Wherein garbage is put into higher end of slanting set recycle bin from feed hopper of garbage-collecting bin, meshes in large aperture are made over recycle bin, its lower end is extended to connect with conveying device in manpower-selecting zone; conveying belt with casing fixed at bottom of recycle bin is to convey garbage dropping from mesh in big aperture, its lower edge is connected with conveying device, then, another conveying device extends into the higher end of recycle bin, meshes in small aperture are distributed over this recycle bin, conveying belt and conveying device collecting minute-sieved garbage are also fixed below recycle bin, which can convey garbage dropping from small aperture mesh, furthermore, another set of conveying device is fixed at lower end of recycle bin; therefore, this facility can be applied to initial/minute sieving for garbage-sorting.

2. As claimed in claim 1, it is an initial/minute sieving and sorting facility of garbage, wherein driving tooth rings around one end of recycle bin, motor then drive chain to rotate recycle bin, so that garbage in recycle bin can continuously drop off meshes due to its rotation.

3. As claimed in claim 1, it is an initial/minute sieving and sorting facility of garbage, wherein positioning angel of recycle bin and support disc of this invention are better to set below 30.

4. As claimed in claim 1, it is an initial/minute sieving and sorting facility of garbage, wherein meshes of recycle bin with big and small apertures are of 20 cm and 10 cm respectively.
